(19) United States
(12) Patent Application Publication
(10) Pub. No.: US 2002/0188772 A1
(43) Pub. Date: Dec. 12, 2002

(54) Media production methods and systems

(76) Inventors: Mark Radcliffe, Seattle, WA (US); Mei Wilson, Redmond, WA (US); Robert W. Edmiston, Kirkland, WA (US); Brian D. Crites, Sammamish, WA (US)

Correspondence Address: LEE & HAYES PLLC, 421 W RIVERSIDE AVENUE SUITE 500, SPOKANE, WA, 99201

(21) Appl. No.: 10/117,455

(22) Filed: Apr. 1, 2002

Related U.S. Application Data
(60) Provisional application No. 60/280,897, filed on Apr. 2, 2001.

(51) Int. Cl. G06F 3/00; H04N 5/445; G06F 13/00; G06F 3/02; G06F 3/023; G06F 3/05; G06F 3/06; G06F 5/00; H04N 7/173; H04L 12/28; H04L 12/56

(52) U.S. Cl. 710/38; 725/37; 725/93; 370/389

(57) ABSTRACT

Various embodiments enable dynamic control of input sources for producing live (and/or archivable) streaming media broadcasts. A user interface can conveniently enable a single individual to produce a streaming media broadcast using a variety of input sources that can be conveniently grouped, selected, and modified on the fly if so desired. User-defined source groups enable an individual to select and arrange source inputs for the streaming media broadcast. In some embodiments, source groups can have properties and behaviors that can be defined by the individual before and even during a broadcast session.

### RELATED APPLICATIONS

This application stems from and claims priority to U.S. Provisional Application Serial No. 60/280,897, filed Apr. 2, 2001, the disclosure of which is incorporated by reference herein.

### TECHNICAL FIELD

This invention relates to media production methods and systems.

### BACKGROUND

Media production often involves processing data from different sources into a single production, such as a video presentation or a television program. The process by which a single production is produced from the different sources can be a laborious and time-consuming undertaking.

As but one example, consider the case where it is desired to present a series of educational lectures on a particular topic of interest at various remote learning facilities. That is, often times a university or other educational institution will desire to record educational lectures by their professors and offer the lectures as classes at so-called “remote learning” sites. This remote learning scenario can often take place some time after recording the live lecture. Assume that during the course of one lecture, the professor can stand at a lecture podium to address the class, or can move to a white board to make notes for the students to take down. In order to adequately capture the lecture proceedings, two camera sources and one audio source (such as a microphone) might be used. For example, one of the cameras might be centered on the professor while the professor is at the podium, while the other of the cameras is centered at the white board where the professor may make his notes.

As an example, consider FIG. 1 which is a diagrammatic representation of a system 100 that can be utilized to create a production of the professor's lecture that can be used in a “distance learning scenario”. A distance learning scenario is one in which the professor's lecture might be viewed at one or more remote locations—either contemporaneously with the live lecture or some time later.

Here, system 100 includes a first camera 102 that is centered on the white board, and a second camera 104 that is centered on the professor at the podium. A microphone 106 is provided at the podium or otherwise attached to the professor for the professor to speak into. As the professor lectures and writes on the white board, cameras 102, 104 capture the separate actions and record the action, respectively, on individual analog tapes 108a and 108b. Later, at a multimedia post-production lab, the images on the tapes 108a, 108b can be digitized and then further processed to provide a single production. For example, the tape 108a might be processed to provide a number of different “screen captures” 110 of the white board, which can then be integrated into the overall presentation that is 18 provided as multiple files 112 which can then, for example, be streamed as digital data to various remote facilities. For example, one media file can contain the video, audio, and URL script commands which the client browser uses to retrieve HTML pages with the whiteboard images embedded. A single class might then consist of a single media file and perhaps 30 HTML pages and 30 associated JPEG files.

The post-production processing can be both laborious and time-consuming. For example, the video tape of the white board must be processed by a human to provide the individual images of the white board at a desired time after it has been written upon by the professor. These images must further be digitized and then physically linked with the digitized content of tape 108b. This process can require a number of different post-production assistants. Approximately ten man hours are needed to produce just one hour of final production. The labor intensity and associated cost of this approach prevents the university from rolling this out to more than a few classes.

Another solution that has been attempted in the past, in the context of streaming broadcasts to live audiences, is diagrammatically shown in FIG. 2 Streaming media comprises sound (audio) and pictures (video) that are transmitted on a network such as the Internet in a streaming or continuous fashion, using data packets. Typically, as the client receives the data packets, they are processed and rendered for the user.

In FIG. 2, a system 200 includes two cameras 202, 204 and a microphone 206. Assume, for purposes of this example, that we are in the context of the distance learning example above, except in this case, there is an audience at a remote location that is to view the lecture live. The camera outputs are fed into a hardware switch 208 that can be physically switched, by a production assistant, between the two cameras 202, 204. The output of the hardware switch is provided to a computer 210 that processes the camera inputs to provide a streaming feed that is fed to a server or other computer for routing to the live audience. As the professor changes between the podium and the white board, a human operator physically switches the hardware switch to select the appropriate camera. This approach can be problematic for a couple of different reasons. First, this approach is hardware intensive and does not scale very well. For example, two camera inputs can be handled fairly well by the human operator, but additional camera inputs may be cumbersome. Further, there is no opportunity to digitally edit the data that is being captured by the camera. This can be disadvantageous if, for example, the images captured by one of the cameras is less than desirable and could, for example, be improved by a little simple digital editing. Also, in this specific example, this approach prevents the student from seeing the professor and whiteboard simultaneously, thereby rendering the remote experience less financially compelling for remote students. It does not produce as salable a product.

Hence, to date, the various approaches that have been attempted for production editing, either post-production or real time, are less than desirable for a number of different reasons. For example, production editing can be very laborious and time consuming (as the post-production example above demonstrates). Additionally, in “live” scenarios, there is not a great deal of flexibility that is provided for the individuals involved in the production process. This is due, in part, to the hardware-intensive solutions that are typically employed. In addition, these various solutions are not very easily scalable. That is, assume that someone wishes to produce a number of different media productions. This can require a great deal of duplication of effort and costly resources which can quickly become cost prohibitive.

Accordingly, this invention arose out of concerns associated with providing improved media production methods and systems.

### SUMMARY

Various embodiments enable dynamic control of input sources for producing live (and/or archivable) streaming media broadcasts. Various embodiments provide dynamic, scalable functionality that can be accessed via a user interface that can conveniently enable a single individual to produce a streaming media broadcast using a variety of input sources that can be conveniently grouped, selected, and modified on the fly if so desired. The notion of a source group that can comprise multiple different user-selectable input sources is introduced. Source groups provide the individual with a powerful tool to select and arrange inputs for the streaming media broadcast. In some embodiments, source groups can have properties and behaviors that can be defined by the individual before and even during a broadcast session.

### BRIEF DESCRIPTION OF THE DRAWINGS

FIG. 1 is a diagrammatic representation of a prior art production creation process.

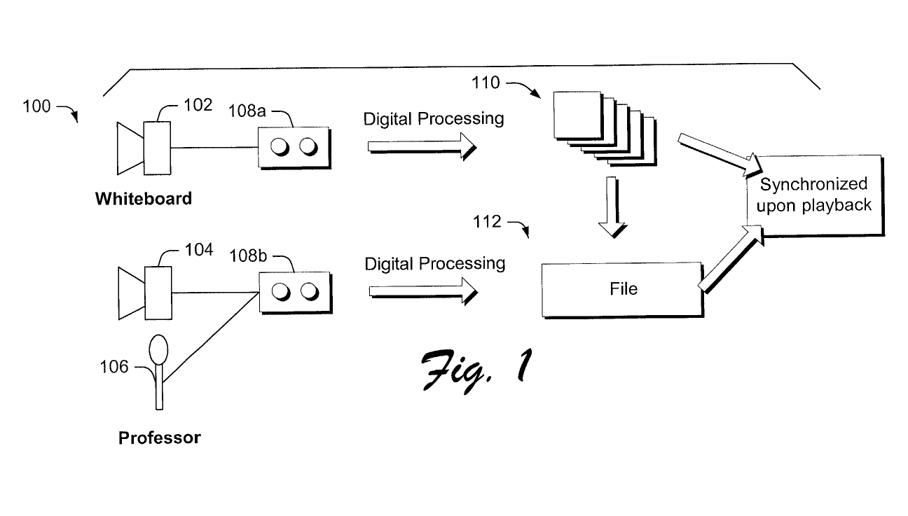

FIG. 2 is a diagrammatic representation of another prior art production creation process.

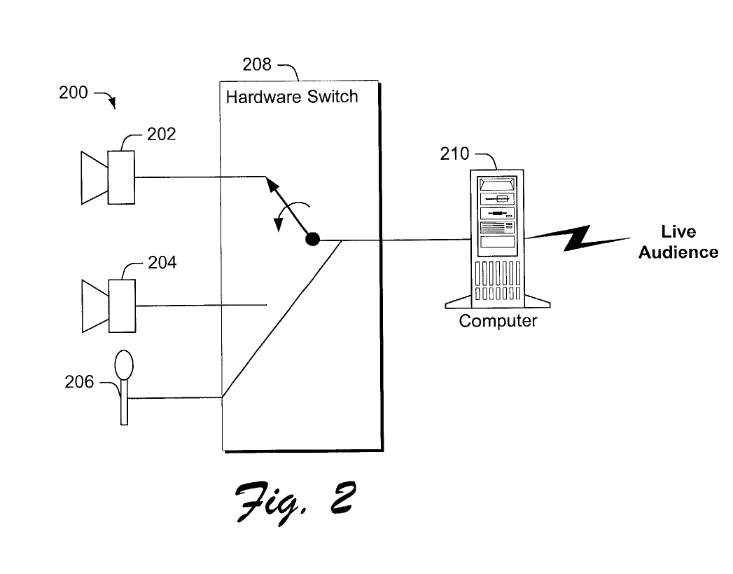

FIG. 3 is a block diagram of an exemplary computer system that can be utilized to implement one or more embodiments.

FIG. 4 is a block diagram of an exemplary switching architecture in accordance with one embodiment.

FIG. 5 is a block diagram illustrating various aspects of one embodiment.

FIG. 6 illustrates an exemplary user interface in accordance with one embodiment.

FIG. 7 illustrates an exemplary user interface in accordance with one embodiment.

FIG. 8 is a flow diagram that describes steps in a method in accordance with one embodiment.

FIG. 9 illustrates an exemplary display that can be provided for a user to facilitate the production process.

FIG. 10 is a flow diagram that describes steps in a method in accordance with one embodiment.

FIG. 11 illustrates a display in accordance with one embodiment.

FIG. 12 illustrates an exemplary system in accordance with one embodiment.

FIG. 13 is a flow diagram that describes steps in a method in accordance with one embodiment.

### DETAILED DESCRIPTION

### Overview

Various embodiments described below enable dynamic control of input sources for producing live (and/or archivable) streaming media broadcasts. This constitutes an important improvement over past approaches that are, for the most part, generally static in nature and/or heavily hardware-reliant and require intensive individual involvement. Various embodiments provide dynamic, scalable functionality that can be accessed via a user interface that can conveniently enable a single individual to produce a streaming media broadcast using a variety of input sources that can be conveniently grouped, selected, and modified on the fly if so desired. The notion of a source group that can comprise multiple different sources is introduced and provides the individual with a powerful tool to select and arrange inputs for the streaming media broadcast. Source groups can have properties and behaviors that can be defined by the individual before and even during a broadcast session.

### Exemplary Computer Environment

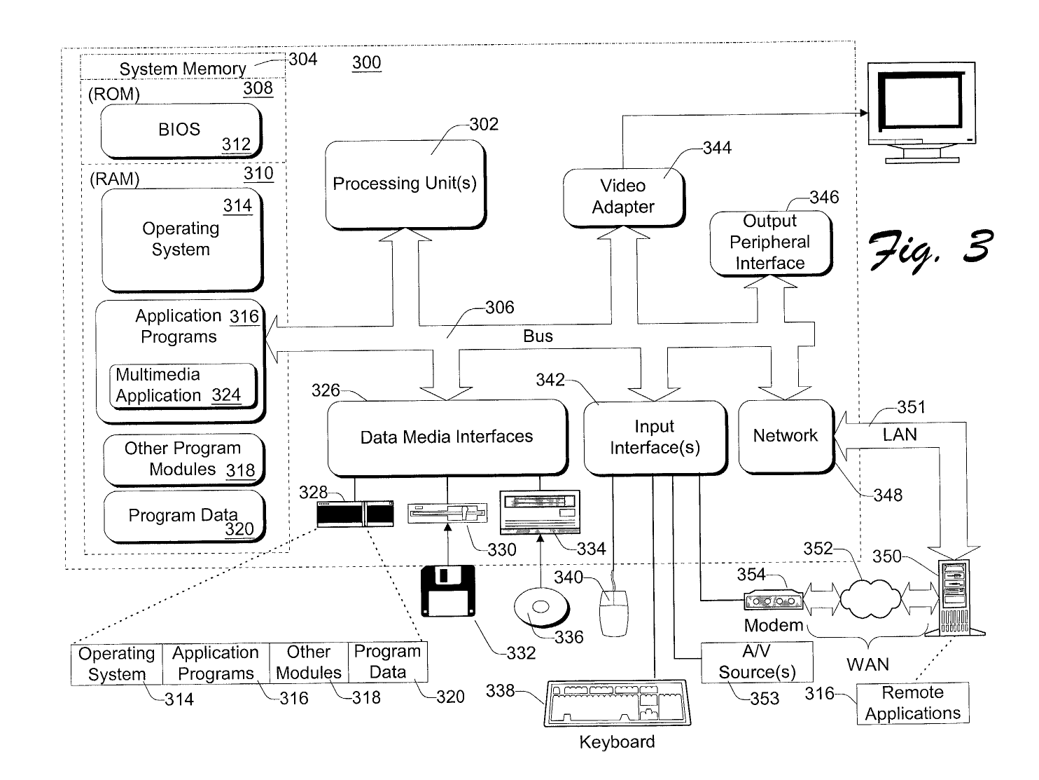

FIG. 3 illustrates an example of a suitable computing environment 300 on which the system and related methods described below can be implemented.

It is to be appreciated that computing environment 300 is only one example of a suitable computing environment and is not intended to suggest any limitation as to the scope of use or functionality of the media processing system. Neither should the computing environment 300 be interpreted as having any dependency or requirement relating to any one or combination of components illustrated in the exemplary computing environment 300.

The inventive techniques can be operational with numerous other general purpose or special purpose computing system environments, configurations, or devices. Examples of well known computing systems, environments, devices and/or configurations that may be suitable for use with the described techniques include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments, hand-held computing devices such as PDAs, cell phones and the like.

In certain implementations, the system and related methods may well be described in the general context of computer-executable instructions, such as program modules, being executed by a computer. Generally, program modules include routines, programs, objects, components, data structures, etc. that perform particular tasks or implement particular abstract data types. The inventive techniques may also be practiced in distributed computing environments where tasks are performed by remote processing devices that are linked through a communications network. In a distributed computing environment, program modules may be located in both local and remote computer storage media including memory storage devices.

In accordance with the illustrated example embodiment of FIG. 3 computing system 300 is shown comprising one or more processors or processing units 302, a system memory 304, and a bus 306 that couples various system components including the system memory 304 to the processor 302.

Bus 306 is intended to represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 300 typically includes a variety of computer readable media. Such media may be any available media that is locally and/or remotely accessible by computer 300, and it includes both volatile and non-volatile media, removable and non-removable media.

In FIG. 3, the system memory 304 includes computer readable media in the form of volatile, such as random access memory (RAM) 310, and/or non-volatile memory, such as read only memory (ROM) 308. A basic input/output system (BIOS) 312, containing the basic routines that help to transfer information between elements within computer 300, such as during start-up, is stored in ROM 308. RAM 310 typically contains data and/or program modules that are immediately accessible to and/or presently operated on by processing unit(s) 302.

Computer 300 may further include other removable/non-removable, volatile/non-volatile computer storage media. By way of example only, FIG. 3 illustrates a hard disk drive 328 for reading from and writing to a non-removable, non-volatile magnetic media (not shown and typically called a “hard drive”), a magnetic disk drive 330 for reading from and writing to a removable, non-volatile magnetic disk 332 (e.g., a “floppy disk”), and an optical disk drive 334 for reading from or writing to a removable, non-volatile optical disk 336 such as a CD-ROM, DVD-ROM or other optical media. The hard disk drive 328, magnetic disk drive 330, and optical disk drive 334 are each connected to bus 306 by one or more interfaces 326.

The drives and their associated computer-readable media provide nonvolatile storage of computer readable instructions, data structures, program modules, and other data for computer 300. Although the exemplary environment described herein employs a hard disk 328, a removable magnetic disk 332 and a removable optical disk 336, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 328, magnetic disk 332, optical disk 336, ROM 308, or RAM 310, including, by way of example, and not limitation, an operating system 314, one or more application programs 316 (e.g., multimedia application program 324), other program modules 318, and program data 320. A user may enter commands and information into computer 300 through input devices such as keyboard 338 and pointing device 340 (such as a “mouse”). Other input devices may include a audio/video input device(s) 353, a microphone, joystick, game pad, satellite dish, serial port, scanner, or the like (not shown). These and other input devices are connected to the processing unit(s) 302 through input interface(s) 342 that is coupled to bus 306, but may be connected by other interface and bus structures, such as a parallel port, game port, or a universal serial bus (USB).

A monitor 356 or other type of display device is also connected to bus 306 via an interface, such as a video adapter 344. In addition to the monitor, personal computers typically include other peripheral output devices (not shown), such as speakers and printers, which may be connected through output peripheral interface 346.

Computer 300 may operate in a networked environment using logical connections to one or more remote computers, such as a remote computer 350. Remote computer 350 may include many or all of the elements and features described herein relative to computer.

As shown in FIG. 3, computing system 300 is communicatively coupled to remote devices (e.g., remote computer 350) through a local area network (LAN) 351 and a general wide area network (WAN) 352. Such networking environments are commonplace in offices, enterprise-wide computer networks, intranets, and the Internet.

When used in a LAN networking environment, the computer 300 is connected to LAN 351 through a suitable network interface or adapter 348. When used in a WAN networking environment, the computer 300 typically includes a modem 354 or other means for establishing communications over the WAN 352. The modem 354, which may be internal or external, may be connected to the system bus 306 via the user input interface 342, or other appropriate mechanism.

In a networked environment, program modules depicted relative to the personal computer 300, or portions thereof, may be stored in a remote memory storage device. By way of example, and not limitation, FIG. 3 illustrates remote application programs 316 as residing on a memory device of remote computer 350. It will be appreciated that the network connections shown and described are exemplary and other means of establishing a communications link between the computers may be used.

### Exemplary Switching Architecture

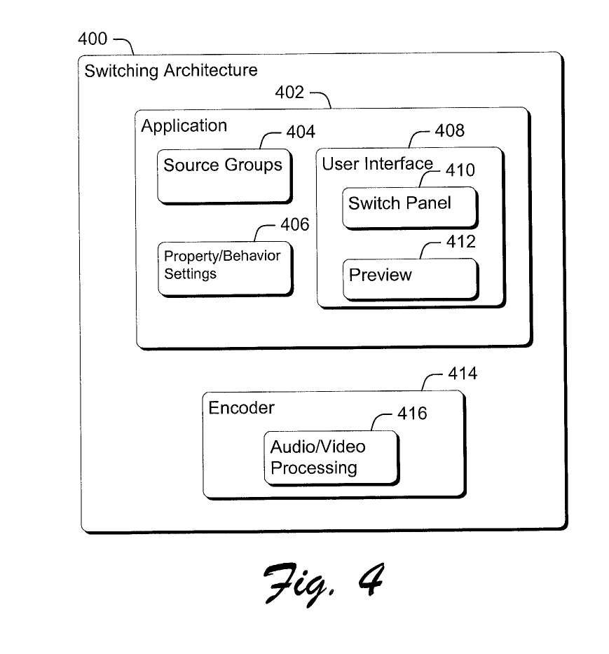

FIG. 4 shows an exemplary switching architecture 400 in accordance with one embodiment. The architecture can be implemented in connection with any suitable hardware, software, firmware or combination thereof. Advantageously, the switching architecture itself can be implemented in software. The software can typically reside on a computer, such as the one shown and described in connection with FIG. 3.

Here, the switching architecture 400 comprises an application 402 having various components that can facilitate the media production process. For example, application 402 provides functionality to enable a user to select and define one or more source groups 404. A source group can be thought of as a set of input sources and properties that together define an input when a particular switch or button is activated. Application 402 also enables a user to select and define property and behavior settings 406 for individual sources or source groups. This will become more evident below. Further, a user interface 408 is provided and includes a switch panel 410 that displays, for a user, indicia (such as switches or buttons) associated with the particular source groups so that the user can quickly and conveniently select a source group. An optional preview component 412 provides the user with a visual display of one or more of the various source inputs or source groups. This can assist the user in visually determining when an appropriate transition should be made between source groups.

Switching architecture 400 can also include an encoder 414 having a audio/video processing component 416 that processes the output from the source groups, applies compression to the output and produces digital media output that can be streamed for a live broadcast and/or written to an archive file. Having an archive file can be advantageous from the standpoint of being able to present a presentation “on demand” at some later time.

### EXAMPLE

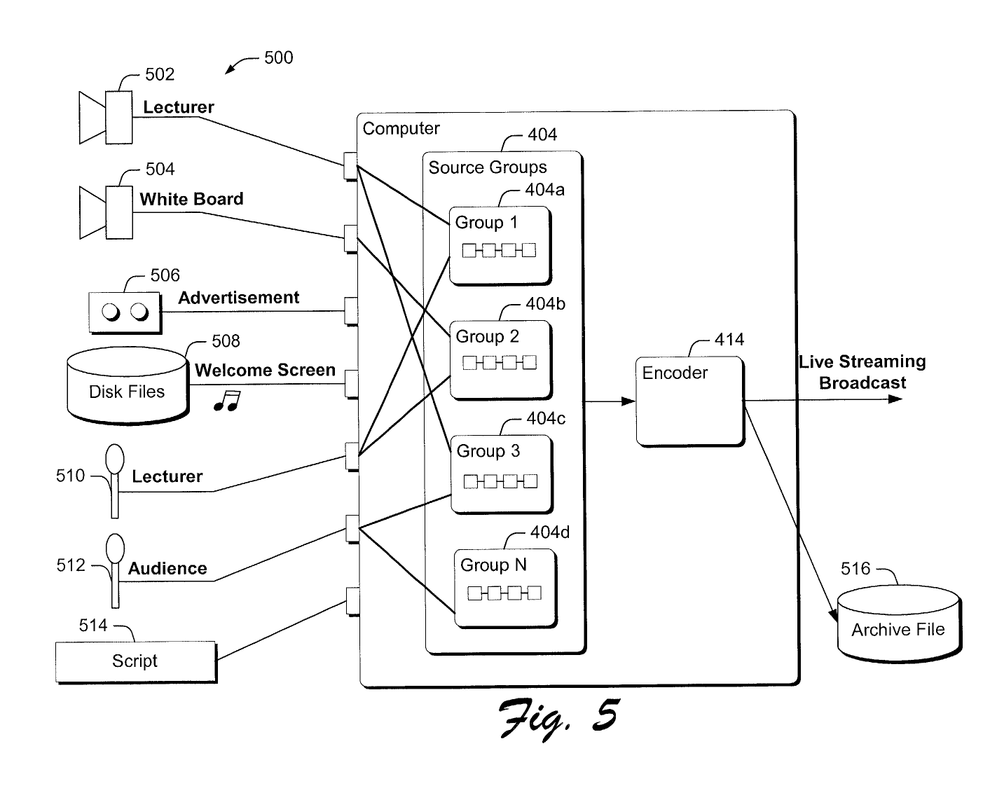

To assist in understanding how switching architecture 400 can be applied, consider the example set forth in FIG. 5. There, a number of different types of source inputs 500 are provided and include cameras 502, 504 (one positioned to capture a lecturer, and other positioned to capture a white board), a tape 506 (having, for example, an advertisement), disk files 508 (having, for example, a file that presents a welcome message along with accompanying music), two microphones 510, 512 (one of which for the lecturer, the other of which for an audience), and script 514 (which can provide textual information, such as close captioning text). The individual source inputs are provided directly into a computer via suitable ports or connectors. Each of the camera inputs and/or microphone inputs can be provided to suitable capture cards within the computer.

The source groups typically do not care what type of input (e.g. camera, video tape, microphone) is attached to the computer. In this embodiment, the is source groups deal purely with data of a specific type (e.g. video data, audio data, text data (also known as “script” data)). These data types can also include HTML data, third-party data, and the like. Each data type can be “sourced” from various places including a video card (for video data), an audio card (for audio data), a keyboard (for text data), a disk file (for video, audio and/or text data), another program and/or software component (for video, audio and or text/data), another computer across a network or similar connection (for video, audio and/or text data).

In the case where a source group reads the video, audio, and/or text data from a hardware card, anything that can be plugged into the card can be a source input. A non-exhaustive, non-limiting list of source inputs can include: camera (video and/or audio), video tape deck (video, audio and/or text), DVD player (video, audio and/or text), digital video recorder (video, audio and/or text), laserdisk player (video, audio and/or text), TV tuner (video, audio and/or text), microphone (audio), radio tuner (audio), audio tape deck (audio), CD player (audio), MD player (audio), DAT player (audio), telephone (audio), disk file (video, audio and/or text), another computer (video, audio and/or text), another program or software module (video, audio and/or text), to name just a few.

In this example, the user has defined a number of different source groups 404 that comprise one or more of the source inputs. For example, source group 404a comprises the source input from camera 502 and microphone 510; source group 404b comprises the source input from camera 504 and microphone 510; source group 404c comprises the source input from camera 502 and microphone 512; and source group 404d comprises the source input from microphone 512.

In this particular example, the user has selected source group 404a such that the resultant data stream is that which includes the video and the audio of the lecturer. This might be used when the lecturer is standing at a podium and speaking. Source group 404b has been selected such that the resultant data stream is that which includes the video of the white board and the audio from the lecturer. This can be used when, for example, the lecturer moves to the white board to make notes. Source group 404c has been selected such that the resultant data stream is that which includes the video of the lecturer and the audio from the audience. This can be used when, for example, the lecturer opens the floor to questions from the audience. Source group 404d has been selected such that the resultant data stream is that which includes only the audio from the audience.

As a user selects from among the various source groups, the source data from each of the input sources comprising that source group is provided to encoder 414 and processed to provide digital media output that can be streamed for a live broadcast and/or written to an archive file 516.

Notice that individual source inputs can be used for one or more source groups and not just a single group. Specifically, notice that the source input from camera 502 is provided to both source groups 404a and 404c. This is advantageous as it can flexibly enable the user to select an appropriate and desirable mix of source inputs for a particular source group. For example, a viewer's experience can be enhanced when the viewer can not only hear the questions from the audience, but can visually observe the lecturer's reactions to the questions, as source group 404c permits.

In this particular example, each of the source groups has its own digital data flow pipe, indicated diagrammatically inside of the individual source groups. The purpose of the data flow pipes is to process the data that each source group receives, as will be understood by those of skill in the art. Individual components that comprise the data flow pipes can include source components that generate/source the source data from a hardware device or another software component, source transform components that modify the source data from an individual source component or another transform component, source group transform components that modify the source data simultaneously from all source components or all other transform components.

When a particular source group is not active, in this example, the source group's data pipe has no data flow. When a source group is activated, the corresponding data pipe is activated so that it can process the digital data. Typically, the digital data that is processed by a data pipe is processed in units known as “samples”. Each sample typically has a timestamp associated with it, as will be understood by those of skill in the art. The timestamps can be used to organize and schedule presentation of the data samples for a user, among other things. In this particular example, the timestamps for the data samples that are processed by each of the source groups are processed in a manner such that they appear to emanate from a single source. That is, rather than re-initializing the timestamps for each source group as it is activated and re-activated, the timestamps for the different samples are assigned in a manner that defines an ordered, logical series of samples. For example, if a collection of data samples are processed by one source group and correspond to timestamps from t=1:00 to t=2:00 and then the user switches to a different source group, the timestamps for the data samples for the new source group will begin with a timestamp of t=2:01 and so on.

Additionally, data that emanates from different source groups can emanate in a slightly different format. For example, in some cases, one camera might record at a resolution of 640×480, while another camera might record at a resolution of 320×245. If this is the case and if so desired, the source groups and, more particularly the data pipes within the source groups can additionally process the data so that it is more standardized in its appearance as by reformatting the data and the like.

### Defining Source Groups

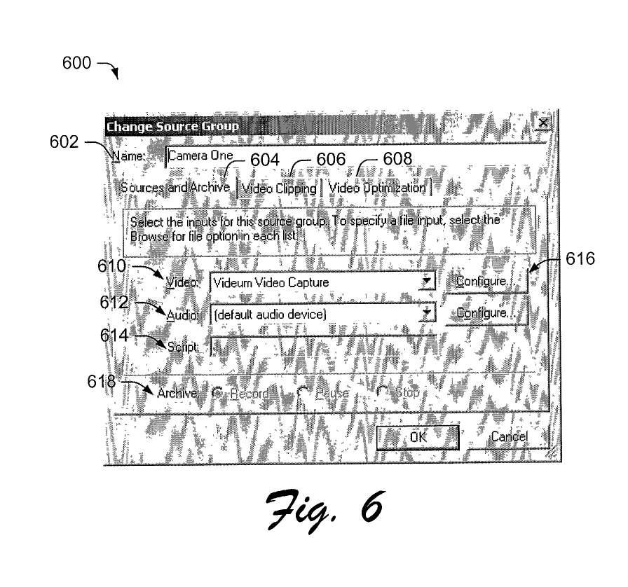

As noted above, a user can define one or more source groups to include one or more source inputs. The same source input can be used for more than one source group. In accordance with one embodiment, the user can define the source group via a user interface that is presented to them before or during a session (either “live” for immediate broadcast or to create an “on demand” file for later presentation). That is, one advantage of the present system is that a user can define source groups ahead of time (i.e. before a session), or on the fly (i.e. during a session). As an example user interface, consider FIG. 6 which shows an exemplary user interface 600.

Individual source groups can be made up of one or more source inputs. Individual source groups can have properties and behaviors associated with them as well. As but examples of some properties, a source group can have a name property 602, media source property 604 (video capture card, audio input, etc.), a video clipping property 606 (which can allow for clipping of regions of the video), and a video optimization property 608 (which can allow the user to manipulate parameters associated with the encoding process).

In this example, the user has selected the media source property 604 which allows the user to define where the input for this source group comes from. For example, for this particular project, the user can select a video input property 610, an audio input property 612, and a script property 614. Configuration properties 616 associated with each of properties 610-614 can allow the user to manipulate the various configurations of the individual input sources (e.g. video capture device settings and the like).

Another property that the source groups can have is a “transform” property, which is not shown in the figure. A transform property is similar to an “effect”. In the video context, an example of a transform is a watermark or logo that can be placed in a predetermined area of the video. Additionally, transforms can have properties and behaviors as well. As an example, on the video sources, a transform can be selected to add a watermark or logo on the lecturer and white board source inputs, but not on the advertisement source input. This will prevent the user from viewing the watermark or logo when the advertisement is run. Additional transforms can include, without limitation, audio transforms such as audio sweetening and audio normalization (as between different source inputs). Yet other transforms can include time compression transforms which can times compress the source input. In addition, more than one transform can be applied on a particular input source.

Further, transforms can be source-specific or source group-specific. An example of a source group-specific transform is time compression. That is, a time compression transform can operate on all of the different input data types defined by the source group.

Source groups can also have behaviors associated with them which affect the behavior of the source group during a broadcast session. In this particular example an exemplary behavior is shown at 618 in the form of an archive behavior. The archive behavior enables the user to select a setting that controls how the archive file (such as archive file 515 in FIG. 5) is engaged by the source group during a broadcast session. In this particular example, there are three settings that can be selected by the user—“Record”, “Pause”, and “Stop”.

As an example of how this particular behavior can be useful, consider the following. There may be instances where, for example, a user does not want those who later experience the disk file to experience possibly everything that takes place during the original broadcast. For example, assume that in the middle of a broadcast there is going to be a ten minute intermission. During this time, the people who are viewing the live presentation are going to have some advertisement rendered for them to view along with some musical accompaniment (as a source group). However, those individuals who are viewing the media stream at a later time may not necessarily need to view the advertisement for ten minutes.

By using source group behaviors the user can, in effect, program the source groups to behave in a predetermined way during the broadcast. Here, for example, when the source group associated with the lecturer is selected, there is also a behavior associated with that source group that says “record to the archive”. Similarly, when the source group associated with the advertisement is selected, there is a behavior that says “pause to the archive”. Thus, the stream to the archive file can be automatically paused when the appropriate source group is selected.

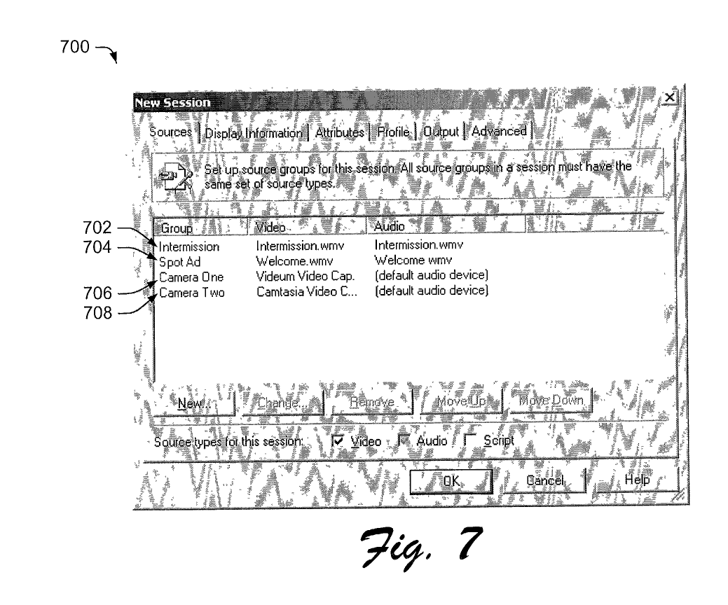

FIG. 7 shows a user interface 700 that is associated with a broadcast session. Here, the user has defined four source groups 702, 704, 706, and 708. Source groups can be added (by clicking on the “New” button), have their properties modified, and can have their order (i.e. the order in which they are displayed to the user) in the session changed. It is noteworthy to consider that source groups can be added and manipulated before a session and/or during a session.

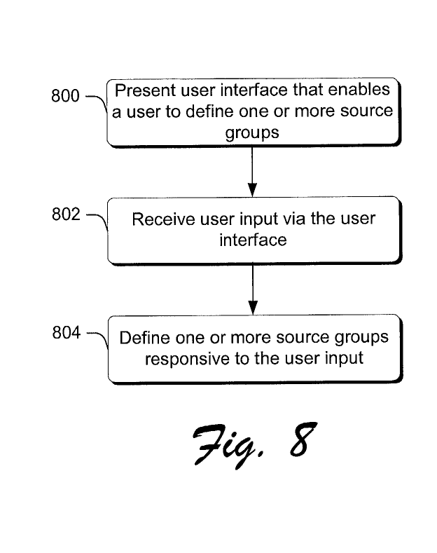

FIG. 8 is a flow diagram that describes steps in a method in accordance with one embodiment. The steps can be implemented in connection with any suitable hardware, software, firmware or combination thereof In the present example, the steps are implemented in software. But one exemplary software architecture that is capable of implementing the method about to be described is shown and described in connection with FIG. 4.

Step 800 presents a user interface that enables a user to define one or more source groups. Exemplary interfaces are shown and described above in connection with FIGS. 6 and 7. Step 802 receives user input via the user interface. Such input can comprise any suitable input including, but not limited to, source group name, source inputs to comprise the source group, source group properties, and source group behaviors. Examples of properties and behaviors are given above. Step 804 defines one or more source groups responsive to the user input.

### Switching Between Source Groups

Once the user has defined the various source groups for a particular broadcast session, once the broadcast starts, the user can begin to arrange their media production in real time. That is, the user can not only select source groups to provide the streaming data for an off-site broadcast (and archive file if so desired), but they can dynamically add, remove and manipulate the source groups during the broadcast as well.

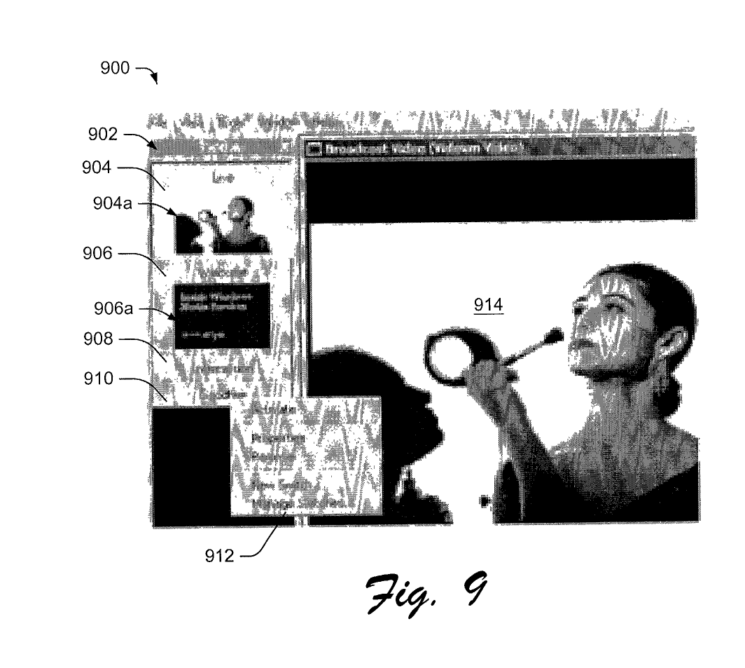

FIG. 9 shows one exemplary user interface 900 that can be provided and used by a user to edit or otherwise create a media production during a broadcast. The user interface comprises a switch panel 902 (corresponding to switch panel 410 in FIG. 4) that displays indicia or switches associated with each source group defined by the user. In this particular example, there are four source groups that have been defined by the user and for which switches appear: a “live” switch 904 that is associated with a camera that captures live action, a “welcome” switch 906 that displays a welcome message, an “intermission” switch 908 associated with information that is to be displayed during an intermission, and a “goodbye” switch 910 that is associated with information that is to be displayed when the session is about to conclude. In addition, a dialog 912 is provided and enables a user to access and/or edit switch properties, remove and add switches, and manage the switches.

Advantageously, switch panel 902, in some embodiments, can have a preview portion (corresponding to preview component 412 in FIG. 4) that provides a small display (similar to a thumbnail view) of the input on or near a switch for a particular source group to assist the user in knowing when to invoke a particular switch or source group. For example, notice that switches 904 and 906 have associated preview portions 904a, 906a respectively. The preview portions provide a display of the current input (or that input which will be displayed if the switch is selected) for a particular switch.

Notice also that a main view portion 914 is provided and constitutes the current output of the encoder (i.e. the content that is currently being broadcast and/or provided into the archive file). In this way, the user can see not only the currently broadcast content, but can have a preview of the content that they can select.

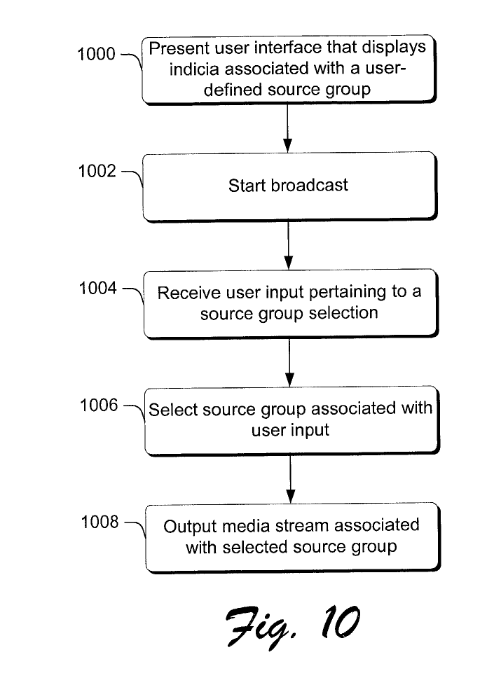

FIG. 10 is a flow diagram that describes steps in a method in accordance with one embodiment. Various steps can be implemented in connection with any suitable hardware, software, firmware or combination thereof. In the present example, various steps are implemented in software. But one exemplary software architecture that is capable of implementing the method about to be described is shown and described in connection with FIG. 4.

Step 1000 presents a user interface that displays indicia associated with a user-defined source group. But one exemplary user interface is shown and described in connection with FIG. 9. There, the displayed indicia comprises a switch panel that includes individual switches that are associated with each of the user-defined source groups. In addition, the indicia can comprise, for some source groups, a preview of the source input as noted above. Step 1002 starts a broadcast. This step can be implemented by, for example, producing an output media stream that is associated with a “welcome” screen or the like. This output stream can be streamed over a network, such as the Internet, to a remote audience. Alternately or additionally, the output stream can be provided into an archive file for later viewing or listening.

Step 1004 receives user input pertaining to a source group selection. This step can be implemented pursuant to a user selecting a particular source group. In the FIG. 9 example, this step can be implemented pursuant to a user clicking on a particular switch that is associated with a particular source group. Step 1006 selects the source group associated with the user input and step 1008 outputs a media stream that is associated with the selected source group.

### Broadcast Display—Streaming Multiple Streams

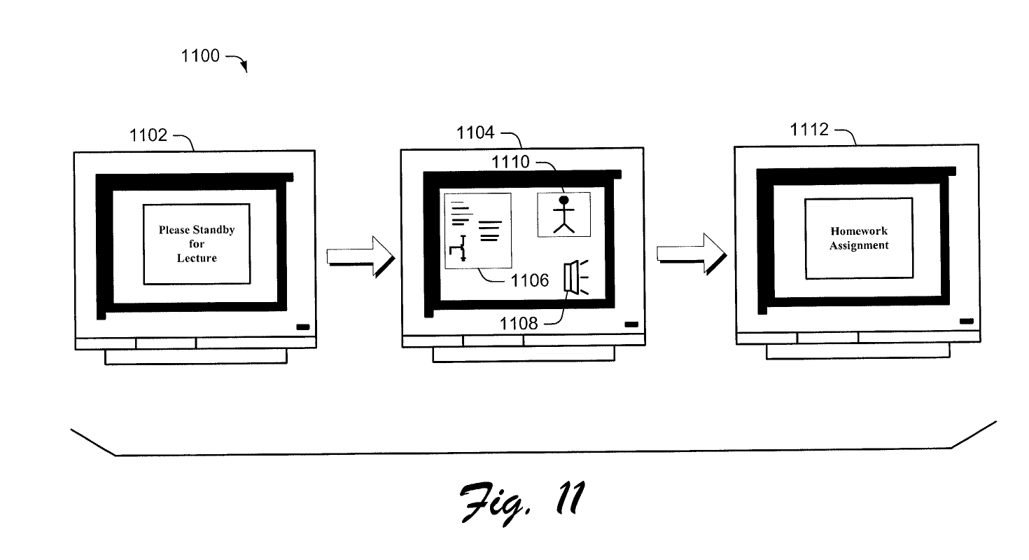

In some embodiments, the switching architecture 400 (FIG. 4) can be configured to output multiple streams, for example video streams, that can be streamed to a viewer's display monitor and rendered at different rendering locations on the display monitor. Advantageously, in the video context, these different streams can be configured for rendering at different frame rates and video qualities. Consider again the example of FIG. 5 in connection with FIG. 11.

In FIG. 5 recall that camera 502 is set up to film the lecturer and camera 504 is set up to film the white board. When camera 502 is filming the lecturer and the lecturer is talking, it can be advantageous, for presentation purposes, to have a high frame rate so that the motion of the lecturer is smooth and not jittery. The resolution of the lecturer may not, however, be as important as the frame rate, as the data stream associated with the lecturer may be designated for rendering in a somewhat smaller window on a viewer's display.

The whiteboard camera 504, on the other hand, need not necessarily be configured to film at such a high frame rate, as the motion with respect to information appearing on the white board is negligible-that is, once the writing is on the white board, it does not move around. What is important about the white board images, though, is that the images need to be big enough and be of high enough resolution for the viewers to read on their display. Thus, if the ultimately rendered images of the white board are too small, they are worthless.

To address this and other problems, some embodiments can provide different media streams that are configured to be rendered at the same time, at different frame rates and at different resolutions on different areas of a viewer's display.

As an example, consider FIG. 11 which shows, at 1100, a single display or monitor depicted at three different times 1102, 1104, and 1112 during a broadcast session. The display or monitor is one that could, for example, be located at a location that is remote from where the lecture is actually taking place. During time 1102, a welcome or standby message is displayed for the viewer or viewers. At time 1104 the lecture has begun and the lecturer has written upon the white board. Notice that the display depicts three different renderings that are being performed. First, a window 1106 is rendered and includes the images of the white board. The rendering within this window takes place at a low frame rate and a high resolution. Another somewhat smaller window 1110 is rendered and includes the images of the lecturer rendered at a high frame rate and a low resolution. A speaker 1108 indicates that an audio stream is being rendered as well.

At time 1112, the lecturer has concluded and a homework assignment can be posted for the viewers.

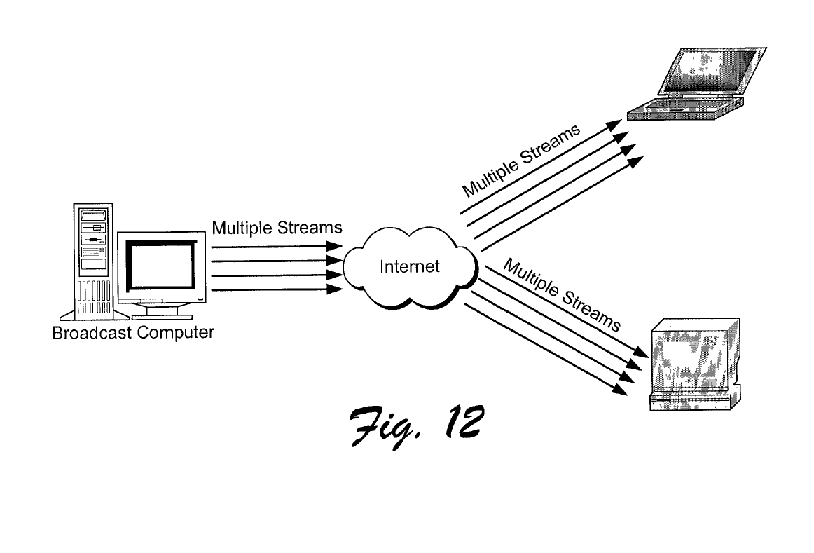

FIG. 12 shows an exemplary system in which a broadcast computer, such as the computer shown in FIG. 5, processes data associated with a broadcast session and produces multiple different media streams that are streamed, via a network such as the Internet, to one or more computing devices. Here, two exemplary computing devices are shown. The different media streams can comprise multiple different video streams. In addition, these video streams can be different types of video streams that embody different video stream parameters. For example, the video streams can comprise data at different frame rates and/or different resolutions. Additionally, these video streams can be configured such that they are renderable in different sized windows on a display. The most notable difference for the different video streams lies in differences of the streaming bitrate of the streams. This can be very significant in that it enables a single piece of content to be sourced to a server which can be re-tasked and distributed to client playback machines across various types of modems and network infrastructures at varying bitrates.

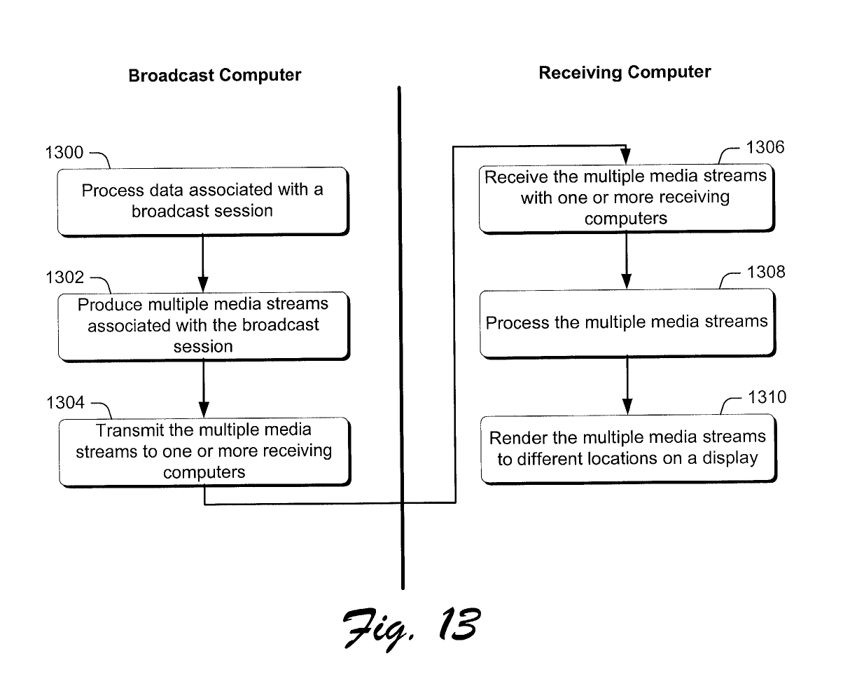

FIG. 13 is a flow diagram that describes steps in a method in accordance with one embodiment. Various steps can be implemented in connection with any suitable hardware, software, firmware or combination thereof. In the present example, the steps are implemented in software. Notice that the flow diagram is divided into two sections-one designated “Broadcast Computer” and the other designated “Receiving Computer”. This is intended to depict which entity performs which steps. For example, the steps appearing under the heading “Broadcast Computer” are performed by a computer that broadcasts a particular broadcast session. An example of such a computer is shown and described in connection with FIG. 5. Additionally, the steps appearing under the heading “Receiving Computer” are performed by one or more computers that receive the broadcast media stream produced by the broadcast computer. These receiving computers can be located at remote locations.

Step 1300 processes data associated with a broadcast session. Examples of how this can be implemented are shown and described above in connection with FIGS. 4-10. Step 1302 produces multiple media streams associated with the broadcast session. These multiple media streams can be different types of media streams such as different types of video streams. Step 1304 transmits the multiple media streams to one or more receiving computers. This step can be implemented in the following way. All of the media streams (be it one or multiple streams of the same data type or different types) can be combined together into a single overall stream using a special data format called ASF (Active Streaming Format). The ASF data stream is then transmitted and the receiving computer separates the constituent media streams out of the ASF stream.

Step 1306 receives the multiple media streams with one or more receiving computers. Step 1308 processes the multiple media streams (as by, for example, separating an ASF stream as noted above) and step 1310 renders the multiple media streams to different locations on a display. Steps 1308 and 1310 can be implemented by a suitably configured media player that can process and render multiple different streams. An example of what this looks like is provided and discussed in connection with FIG. 11.

### Conclusion

The methods and systems described above constitute a noteworthy advance over the present state of media production. Post-production expenditure of labor and time can be virtually eliminated by virtue of the inventive systems that permit real time capture, editing and transmission of a broadcast session. Moreover, the number of people required to produce a broadcast session can be drastically reduced by virtue of the fact that a single individual, via the inventive systems and methods, has the necessary tools to quickly and flexibly define various source groups and switch between the source groups to produce a broadcast session. The software nature of various embodiments can also greatly enhance the scalability of the systems and methods while, at the same time, substantially reduce the cost associated with scaling. The efficiency afforded by the present systems can, in some instances, translate one hour of editing time into one hour of broadcast content—an aspect that is unheard of in the past systems.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
providing multiple input sources associated with a broadcast;
switching, via software, between one or more of the input sources during the broadcast; and
producing, responsive to said switching, one or more media output streams associated with one or more of the input sources.

2. The method of claim 1 further comprising transmitting one or more media output streams by combining the one or more media output streams into a single stream and transmitting the single stream to one or more remote locations.

3. The method of claim 2, wherein the one or more media output streams comprise multiple video streams.

4. The method of claim 2, wherein the one or more media output streams comprise multiple different types of video streams.

5. The method of claim 4, wherein the video streams are associated with video having different frame rates.

6. The method of claim 4, wherein the video streams are associated with video having different frame resolutions.

7. The method of claim 4, wherein the video streams are associated with video having different frame rates and resolutions.

8. The method of claim 1 further comprising writing one or more media output streams to an archive file.

9. The method of claim 1 further comprising:
transmitting the one or more media output streams to one or more remote locations; and
writing the one or more media output streams to an archive file.

10. The method of claim 1, wherein the act of switching comprises receiving, via a user interface, user input indicating that a switch between the one or more input sources is desired.

11. One or more computer-readable media having computer-readable instructions thereon which, when executed by one or more computing devices, cause the computing devices to:
receive multiple input sources associated with a broadcast;
receive, via a user interface, user input indicating that a switch between the one or more input sources is desired;
switch, responsive to the user input, between one or more of the input sources during the broadcast; and
produce, responsive to switching between the input sources, one or more media output streams associated with one or more of the input sources.

12. The one or more computer-readable media of claim 11, wherein the instructions cause the one or more computing devices to transmit one or more media output streams to one or more remote locations.

13. The one or more computer-readable media of claim 11, wherein the instructions cause the one or more computing devices to write one or more media output streams to an archive file.

14. The one or more computer-readable media of claim 11, wherein the instructions cause the one or more computing devices to:
transmit one or more media output streams to one or more remote locations; and
write one or more media output streams to an archive file.

15. A software application configured to:
receive multiple input sources associated with a broadcast;
receive, via a user interface, user input indicating that a switch between the one or more input sources is desired;
switch, responsive to the user input, between one or more of the input sources during the broadcast; and
produce, responsive to switching between the input sources, one or more media output streams associated with one or more of the input sources.

16. The software application of claim 15, wherein the application is configured to transmit one or more media output streams to one or more remote locations.

17. The software application of claim 15, wherein the application is configured to write one or more media output streams to an archive file.

18. The software application of claim 15, wherein the application is configured to:
transmit one or more media output streams to one or more remote locations; and
write one or more media output streams to an archive file.

19. A computing device embodying the software application of claim 15.

20. An architecture comprising:
a software application configured to enable a user to create a multimedia production; and
software means associated with the software application for enabling the user to select from among and switch between sets of input sources associated with the multimedia production.

21. The architecture of claim 20, wherein the software means comprises one or more source groups that define one or more input sources.

22. The architecture of claim 21, wherein one or more source groups are configured to have properties and behaviors.

23. The architecture of claim 21, wherein one or more source groups are configured to have user-selected properties and behaviors.

24. The architecture of claim 20, wherein the software means comprises one or more user-defined source groups that define one or more input sources.

25. The architecture of claim 20, wherein the software means comprises user interface means for enabling a user to select from among the sets of input sources.

26. A computer embodying the architecture of claim 20.

27. An architecture comprising:
one or more source group components that define one or more input sources associated with a multimedia production;
a user interface component defining a switch panel that can be displayed for a user, the switch panel being configured to enable a user to switch between source groups; and
an encoder component associated with the source group components and configured to produce one or more media output streams associated with source groups that are selected by the user.

28. The architecture of claim 27, wherein the one or more source group components are configured to have user-defined properties.

29. The architecture of claim 27, wherein the one or more source group components are configured to have user-defined behaviors.

30. The architecture of claim 27, wherein the one or more source group components are configured to have user-defined properties and behaviors.

31. The architecture of claim 27, wherein the switch panel comprises a preview component that provides a visual display of at least one input source of a source group.

32. A computer embodying the architecture of claim 27.

33. A method comprising:
providing multiple input sources associated with a broadcast, at least some of the input sources comprising different types of input sources;
switching, via software, between one or more of the input sources during the broadcast; and
producing, responsive to said switching, one or more media output streams associated with one or more of the input sources.

34. The method of claim 33, wherein at least one input source type comprises a video type.

35. The method of claim 33, wherein at least one input source type comprises an audio type.

36. The method of claim 33, wherein at least one input source type comprises a file type.

37. The method of claim 33, wherein at least one input source type comprises a tape type.

38. The method of claim 33, wherein at least one input source type comprises a script type.

39. The method of claim 33, wherein the input source types comprise at least some of the following types: a video type, an audio type, a file type, a tape type, and a script type.

40. One or more computer-readable media having computer-readable instructions thereon which implement the method of claim 33.

41. A computing device embodying the computer-readable media of claim 40.

42. One or more computer-readable media having computer-readable instructions thereon which, when executed by one or more computing devices, cause the computing devices to:
provide multiple input sources associated with a broadcast, at least some of the input sources comprising different types of input sources comprising at least one video type and at least one audio type;
switch, via software, between one or more of the input sources during the broadcast; and
produce, responsive to switching between the one or more input sources, one or more media output streams associated with one or more of the input sources.

43. The computer-readable media of claim 42, wherein the instructions cause the one or more computing devices to provide at least one other different input source type.

44. A software application configured to:
provide multiple input sources associated with a broadcast, at least some of the input sources comprising different types of input sources and comprising at least some of the following types: a video type and an audio type;
switch, via software, between one or more of the input sources during the broadcast; and
produce, responsive to switching between the one or more input sources, one or more media output streams associated with one or more of the input sources.

45. A computing device embodying the software application of claim 44.

46. The software application of claim 44, wherein the input sources comprise at least one input source type that is different from a video type and an audio type.

47. A method comprising:
presenting a user interface that enables a user to define one or more source groups, individual source groups comprising one or more source inputs associated with a media production;
receiving user input via the user interface; and
defining one or more source groups responsive to the user input.

48. The method of claim 47, wherein the multiple source groups can share one or more source inputs.

49. The method of claim 47, wherein the acts of presenting, receiving and defining can be performed during a broadcast associated with the media production.

50. The method of claim 47, wherein individual source groups have associated properties.

51. The method of claim 47, wherein individual source groups have associated behaviors.

52. The method of claim 47, wherein individual source groups have associated properties and behaviors.

53. The method of claim 47, wherein individual source groups have associated user-defined properties and behaviors.

54. One or more computer-readable media having computer-readable instructions thereon which implement the method of claim 47.

55. A computing device embodying the computer-readable media of claim 54.

56. One or more computer-readable media having computer-readable instructions thereon which, when executed by one or more computing devices, cause the computing devices to:
present a user interface that enables a user to define one or more source groups, individual source groups comprising one or more source inputs associated with a media production, the individual source groups having associated properties and behaviors;
receive user input via the user interface; and
define one or more source groups responsive to the user input.

57. A computing device embodying the computer-readable media of claim 56.

58. A software application configured to:
present a user interface that enables a user to define one or more source groups, individual source groups comprising one or more source inputs associated with a media production, the individual source groups having associated properties and behaviors;
receive user input via the user interface; and
define one or more source groups responsive to the user input.

59. A user interface comprising:
a name portion that enables a user to name a source group, individual source groups comprising one or more source inputs associated with a media production; and
one or more property portions that can enable a user to select a source input for the source group.

60. The user interface of claim 59, wherein the source inputs can comprises video or audio source inputs.

61. The user interface of claim 59, wherein the source inputs can comprise different types of source inputs.

62. The user interface of claim 59 further comprising a configuration property associated with one or more of the source inputs that can enable the user to manipulate one or more configurations associated with the source input.

63. The user interface of claim 59 further comprising at least one behavior portion that enables a user to define a behavior for the source group.

64. A user interface comprising:
a switch panel that displays indicia associated with one or more source groups, individual source groups comprising one or more source inputs associated with a media production, the indicia being selectable by a user to switch between source groups and thereby cause at least one media stream associated with the source group to be produced; and
a main view portion that provides a current display associated with said at least one media stream.

65. The user interface of claim 64 further comprising a dialog for enabling the user to access and interact with individual switches.

66. The user interface of claim 65, wherein the dialog enables the user to edit switch properties.

67. The user interface of claim 65, wherein the dialog enables the user to remove switches.

68. The user interface of claim 65, wherein the dialog enables the user to add switches.

69. The user interface of claim 65, wherein the dialog enables the user to manage switches.

70. The user interface of claim 64, wherein the switch panel comprises a preview portion that provides a display associated with a particular source group.

71. A method comprising:
presenting a user interface that displays indicia associated with one or more user-defined source groups, individual source groups comprising one or more source inputs associated with a media production;
starting a broadcast by producing an output media stream that is associated with one or more of the source groups;
receiving, via the user interface, user input pertaining to a source group selection by the user;
responsive to receiving said user input, selecting the source group pertaining to the user input; and
outputting a media stream that is associated with the selected source group.

72. The method of claim 71, wherein the act of presenting comprises displaying indicia comprising a switch panel that includes individual switches that are associated with each of the user-defined source groups.

73. The method of claim 71, wherein the act of presenting comprises:
displaying indicia comprising a switch panel that includes individual switches that are associated with each of the user-defined source groups; and
for at least one of the switches, displaying a preview of source inputs associated with the one switch.

74. The method of claim 71, wherein the act of producing comprises streaming the output media stream over a network.

75. The method of claim 71, wherein the act of producing comprises providing the output media stream to a disk file.

76. The method of claim 71, wherein the act of producing comprises:
streaming the output media stream over a network; and
providing the output media stream to a disk file.

77. One or more computer-readable media having computer-readable instructions thereon which implement the method of claim 71.

78. A computing device embodying the computer-readable media of claim 77.
